(19) United States
(12) Patent Application Publication
(10) Pub. No.: US 2014/0292930 A1
(43) Pub. Date: Oct. 2, 2014

(54) PROCESSING AND APPLICATION OF LIQUID EPOXY ADHESIVE FOR PRINTHEAD STRUCTURES INTERSTITIAL BONDING IN HIGH DENSITY PIEZO PRINTHEADS FABRICATION

(71) Applicants: Yanjia Zuo, Webster, NY (US); Pratima Gattu Naga Rao, Sherwood, OR (US); Mandakini Kanungo, Penfield, NY (US); Hong Zhao, Webster, NY (US); Mark A. Cellura, Webster, NY (US); Robertha Caroline Howell, Wilsonville, OR (US); Santokh S. Badesha, Pittsford, NY (US); John R. Andrews, Wilsonville, OR (US)

(72) Inventors: Yanjia Zuo, Webster, NY (US); Pratima Gattu Naga Rao, Sherwood, OR (US); Mandakini Kanungo, Penfield, NY (US); Hong Zhao, Webster, NY (US); Mark A. Cellura, Webster, NY (US); Robertha Caroline Howell, Wilsonville, OR (US); Santokh S. Badesha, Pittsford, NY (US); John R. Andrews, Wilsonville, OR (US)

(73) Assignee: XEROX CORPORATION, NORWALK, CT (US)

(21) Appl. No.: 13/854,583

(22) Filed: Apr. 1, 2013

(51) Int. Cl. B41J 2/04; B29C 65/48

(52) U.S. Cl. CPC B41J 2/04; B29C 65/48
USPC 347/44; 156/307.5

(57) ABSTRACT

A method for forming an ink jet printhead comprises processing an epoxy adhesive such that negative effects from physical contact with particular inks are reduced or eliminated. Conventional adhesives processed using conventional techniques are known to gain weight, swell, and/or oxidize when exposed to certain inks such as ultraviolet inks and pigmented inks. An embodiment of the present teachings can include processing of an adhesive including a processes a particular adhesive comprising a cresol novolac resin and a dicydiandiamide curing agent using a particular process, such that the resulting epoxy adhesive is suitable for printhead applications.

### FIELD OF THE EMBODIMENTS

The present teachings relate to the field of ink jet printing devices and, more particularly, to methods and structures for high density piezoelectric ink jet print heads and a printer including a high density piezoelectric ink jet print head.

### BACKGROUND OF THE EMBODIMENTS

Drop on demand ink jet technology is widely used in the printing industry. Printers using drop on demand ink jet technology can use either thermal ink jet technology or piezoelectric technology. Even though they are more expensive to manufacture than thermal ink jets, piezoelectric ink jets are generally favored, for example because they can use a wider variety of inks.

Piezoelectric ink jet print heads include an array of piezoelectric elements (i.e., piezoelectric transducers or PZTs). One process to form the array can include detachably bonding a blanket piezoelectric layer to a transfer carrier with an adhesive, and dicing the blanket piezoelectric layer to form a plurality of individual piezoelectric elements. A plurality of dicing saw passes can be used to remove all the piezoelectric material between adjacent piezoelectric elements to provide the correct spacing between each piezoelectric element.

Piezoelectric ink jet print heads can typically further include a flexible diaphragm to which the array of piezoelectric elements is attached. When a voltage is applied to a piezoelectric element, typically through electrical connection with an electrode electrically coupled to a power source, the piezoelectric element bends or deflects, causing the diaphragm to flex which expels a quantity of ink from a chamber through a nozzle. The flexing further draws ink into the chamber from a main ink reservoir through an opening to replace the expelled ink.

The formation of ink jet printheads typically requires lamination of multiple layers of materials as part of their fabrication. Traditional printhead designs may use layers of gold-plated stainless steel sheet metal with features that are photochemically etched and then brazed together to form robust structures. However, with the continued drive to improve cost and performance, use of alternate materials and bonding processes may be used. While polymer layers can be used as a replacement of some sheet metal components, polymers require adhesives with suitable properties to bond to each other and to metal layers.

For example, the adhesive must be chemically compatible with the inks used within the printhead. Further, the adhesive should have certain physical properties that reduce printhead failures during use. An adhesive should have a good bond strength, a low squeeze out to prevent blocking of the fluid path, and should be sufficiently resistant to oxidation with elevated temperatures during use. Also, some adhesives may increase in weight and swell, or become less compliant and more stiff during use when exposed to certain inks and elevated temperatures, which can result in leakage of ink or other failure modes. Some of these failures may occur only after extended use of the printhead.

### SUMMARY OF THE EMBODIMENTS

The following presents a simplified summary in order to provide a basic understanding of some aspects of one or more embodiments of the present teachings. This summary is not an extensive overview, nor is it intended to identify key or critical elements of the present teachings nor to delineate the scope of the disclosure. Rather, its primary purpose is merely to present one or more concepts in simplified form as a prelude to the detailed description presented later.

In an embodiment of the present teachings, a method for forming an ink jet printhead can include mixing a cresol novolac resin with a dicydiandiamide curing agent to result in an epoxy adhesive, dissolving the epoxy adhesive in a solvent to form a dilute epoxy adhesive in a coatable form, and coating a first substrate comprising at least one of a metal and a polymer with the dilute epoxy adhesive. The method may further include B-staging the epoxy adhesive by evaporating the solvent from the dilute epoxy adhesive after coating the first substrate with the dilute epoxy adhesive to form a B-staged thin film epoxy adhesive, contacting the B-staged thin film epoxy adhesive with a second substrate comprising at least one of a metal and a polymer to form a printhead subassembly, wherein the B-staged thin film epoxy adhesive is interposed between the first substrate and the second substrate, and fully curing the B-staged thin film epoxy adhesive to form a fully cured epoxy adhesive and to bond the first printhead substrate to the second printhead substrate using the fully cured epoxy adhesive.

In another embodiment of the present teachings, an ink jet printhead can include a first substrate, a second substrate, and an epoxy adhesive interposed between the first substrate and the second substrate that physically connects the first substrate to the second substrate. The epoxy adhesive can include a cresol novolac resin and a dicydiandiamide curing agent, a material surface flatness of less than or equal to 0.5. microns peak-to-peak, a lap shear strength greater than 200 psi bonding the first substrate to the second substrate, and may be an electrical insulator. The in jet printhead can further include an ink within the ink jet printhead that physically contacts the epoxy adhesive, wherein the ink is an ultraviolet gel ink or a pigmented ink, and the epoxy adhesive has a mass uptake of less than 2% when exposed continuously to the ink for 30 weeks.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a cross section of an exemplary ink jet printhead portion formed in accordance with an embodiment of the present teachings; and

FIG. 2 a perspective view of a printer including one or more printheads in accordance with an embodiment of the present teachings.

It should be noted that some details of the FIGS. have been simplified and are drawn to facilitate understanding of the present teachings rather than to maintain strict structural accuracy, detail, and scale.

### DESCRIPTION OF THE EMBODIMENTS

Reference will now be made in detail to exemplary embodiments of the present teachings, examples of which are illustrated in the accompanying drawings. Wherever possible, the same reference numbers will be used throughout the drawings to refer to the same or like parts.

As used herein, unless otherwise specified, the word “printer” encompasses any apparatus that performs a print outputting function for any purpose, such as a digital copier, bookmaking machine, facsimile machine, a multi-function machine, electrostatographic device, etc. Unless otherwise specified, the word “polymer” encompasses any one of a broad range of carbon-based compounds formed from long-chain molecules including thermoset polyimides, thermoplastics, resins, polycarbonates, epoxies, and related compounds known to the art.

Achieving reliable adhesion between many different ink jet printhead layers and materials, particularly at the harsh environmental conditions found in current ink jet printhead uses, is a concern for device manufacturers. An embodiment of the present teachings can result in a more robust physical adhesive connection between the various laminated layers within a printhead, particularly with regard to resistance to chemically harsh inks such as acrylate-based ultraviolet (UV) inks and pigmented inks, and may result in decreased stresses on the interconnection which electrically couples a piezoelectric transducer (PZT) to a circuit layer such as a printed circuit board or flexible printed circuit.

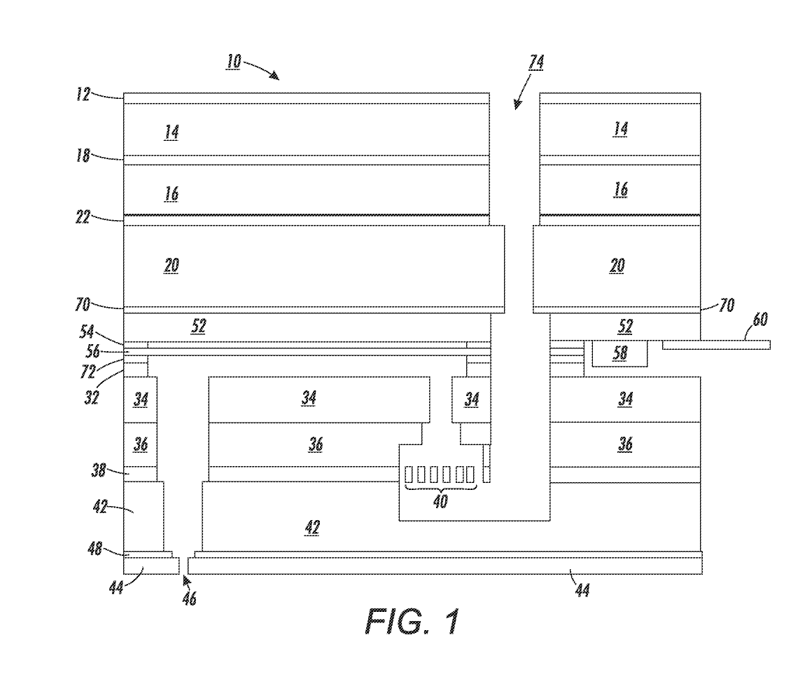

Printhead structures are known in the art and include many layers laminated together. The adhesives used for lamination must resist reaction with chemically harsh inks, bond well to surfaces of different materials to prevent rupture during high-pressure printing, and hold up during high temperature printing, for example during printing with solid inks. FIG. 1 depicts a portion of an exemplary ink jet printhead structure 10 that may be formed using an embodiment of the present teachings. The FIG. 1 printhead structure 10 includes a compliant wall 12, an external manifold 14, and a diverter 16 attached to the external manifold 14 with an external manifold adhesive 18. FIG. 1 further depicts a boss plate 20 attached to the diverter 16 with a diverter attach adhesive 22. In an embodiment, the compliant wall 12 can include thermoplastic polyimide, the external manifold 14 can include aluminum, and the boss plate 20 can include stainless steel. The external manifold 14 can receive liquid ink (not individually depicted for simplicity) during use which has been melted from solid ink blocks, a gel ink, a UV ink, or another liquid ink in preparation for printing, and maintain the ink at a print temperature. FIG. 1 further depicts a body 32, a vertical inlet 34, a separator 36, a particulate filter (rock screen) layer 38 including a rock screen 40, a front end manifold 42, and an aperture plate 44 having a nozzle 46. The aperture plate 44 can be attached to the front end manifold 42 with an aperture plate adhesive 48. In an embodiment, the body 32, the separator 36, and the front end manifold 42 can include a metal such as stainless steel, and the vertical inlet 34, the rock screen layer 38, the aperture plate adhesive 48, and the aperture plate 44 can each include one or more polymers. The assembly 10 can be manufactured according to known processing techniques, such as a process including the use of a stack press under high pressure. FIG. 1 further depicts a substrate 52 such as a semiconductor wafer section, glass layer, metal layer, etc., a standoff layer 54, a printhead diaphragm (membrane) 56, a boss plate adhesive 70, a diaphragm adhesive 72, an application specific integrated circuit (ASIC) 58 attached to the semiconductor wafer section, and an interconnect layer 60 such as a flexible (flex) circuit or printed circuit board electrically coupled to the ASIC 58. As discussed above, the substrate 52 can be a silicon, gallium arsenide, metal, glass, etc. Further, the standoff layer 54 can be silicon dioxide and/or SU-8 photoresist. The diaphragm 56 can be a metal such as titanium, nickel, or a metal alloy. The substrate 52 may include a circuit pattern. It will be appreciated that the depiction of the FIG. 1 is a small portion of a printhead depicting a single ink port 74 and nozzle 46, and that other structures may be added or existing structures may be removed or modified. A printhead with current designs may have four ink inlets, one for each color (cyan, magenta, yellow, and black in a CMYK color model, for example), and 7040 nozzles. The structure of FIG. 1 may be formed using an embodiment of the present teachings and may include a structure in accordance with an embodiment the present teachings.

A desirable adhesive for printhead applications would be able to bond any combination of metal layers (e.g., stainless steel, aluminum, etc.) and/or polyimide layers. In selecting an adhesive, similar formulations may have differing properties and operating characteristics. Extensive in-house testing is required to characterize the properties of an adhesive to determine whether it has the necessary characteristics for a specific use. While a supplier may publish some operating characteristics, other unknown characteristics may be of particular interest to a manufacturer searching for a suitable adhesive and thus characterization of the adhesive by the manufacturer is necessary. A large number of adhesive formulations are commercially available and identifying an adhesive that has the necessary characteristics often presents a formidable challenge. Further complicating the selection is the fact that an adhesive may embody different characteristics at different thicknesses, different application processes, and at different temperatures. Additionally, an adhesive may react differently when exposed to different chemicals having similar formulations, for example to similar but different ink formulations. The variety of combinations of epoxy resins and curing agents provides wide latitude in chemical and mechanical properties at the final cured stage.

An embodiment of the present teachings can include the use of an adhesive for physically attaching together two or more printhead parts. In use, the adhesive may be subjected to harsh chemical inks, such as pigmented inks and UV gel inks and to high temperatures and pressures associated with printing, for example, solid inks. In an embodiment, the adhesive may be an epoxy-based liquid adhesive that is a thermal setting polymer, and may be a TechFilm I2300 (i.e., I2300) available from Resin Designs, LLC of Woburn, Mass., for example a TechFilm I2300L adhesive. In an embodiment, the adhesive, when properly processed in accordance with an embodiment of the present teachings, may enable the fabrication of a high performance, low cost, high density ink jet printhead. The adhesive is chemically resistant to hostile inks used in current printing applications and maintains adhesion in high-temperature, high-pressure printing conditions.

The adhesive identified above, I2300L, is a B-stage, two part epoxy. As with many epoxies, I2300L includes an epoxy resin and an epoxy curing agent (i.e., hardener) which are mixed together to provide the final adhesive. In an embodiment, the epoxy may include a novolac resin and a cresol curing agent to yield high chemical resistance and thermal stability performance. A chemical structure of the cresol novolac resin may be:

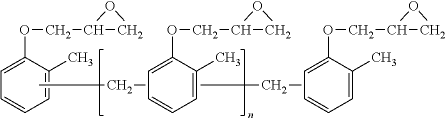

Another chemical structure of the cresol novolac resin may be:

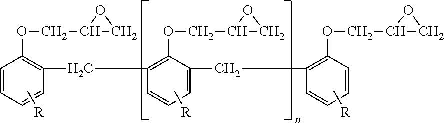

The cresol novolac resin may be a phenolic aromatic organic compound of methylphenol, which are normally solid resins with typical mean epoxide functionality of greater than 2, leading to the formation of a highly crosslinked polymer network displaying high thermal-oxidative stability and chemical resistance.

The curing agent used may be dicydiandiamide (i.e., “DICY”), which has the form:

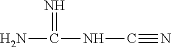

The dicydiandiamide is a representative latent curing agent that forms crystals when processed in accordance with the present teachings. It may be used in the form of a fine powder dispersed within the resin. The material has a very long pot life, for example 6 to 12 months. DICY cures at a high temperature, for example from about 160° C. to about 180° C. in about 20 minutes to about 60 minutes. The cured DICY resins have a good adhesiveness and are less prone to staining than some other resins. DICY may be used in one-part adhesives, powder paints, and pre-impregnated composite fibers (i.e., “pre-pregs”).

In an embodiment, the adhesive may be prepared using a particular process prior to application to a surface that results in the adhesive having various desirable operating characteristics or properties for a printhead fabrication application. Unlike film adhesives that can be cut into different features for interstitial bonding, liquid epoxy requires a special process to be able to dispense in a controlled manner onto a base material of interest (stainless steel, aluminum, polyimide, or a semiconductor, for example). A novel fabrication process has been developed to enable the use of liquid epoxy adhesive for printhead interstitial bonding with minimized squeeze out at high pressure and good bonding strength. From this process, an I2300L-coated polyimide film was successfully prepared. After preparation, the epoxy-coated polyimide film may be laser cut into a desired size and used as a printhead interstitial feature.

The procedure for preparing the epoxy-coated polyimide film may include an embodiment of the following process. While the process described includes the use of a polyimide film as a first substrate on which an epoxy adhesive is formed, it will be understood that the epoxy adhesive may be formed on other substrates, for example a metal layer such as a stainless steel metal layer or aluminum metal layer, or on a polymer other than polyimide.

A cresol novolac resin was mixed with a dicydiandiamide curing agent to result in an epoxy adhesive. In an embodiment, the materials may be mixed in a ratio of between about 99.9 parts (by weight) resin to about 0.1 parts curing agent, or between about 99 parts resin to about 1 parts curing agent, or between about 70 parts resin to about 2 parts curing agent. Either an excess of resin or an excess of curing agent may result in an epoxy adhesive that provides an insufficient bond. For example, excess amount of resin may result in a material that does not completely cure, and an excess of hardener may result in a material that is excessively brittle; either situation may result in leakage of ink between layers during use of the printhead.

Next, the epoxy adhesive was dissolved in a solvent to form a dilute epoxy adhesive in a coatable form that may be coated onto a surface. In an embodiment, the solvent may be methylene chloride, acetone, methyl ethyl ketone (MEK), toluene, 1,2 dimethoxyethane, ethanol, methanol, or mixtures thereof. In an embodiment, the epoxy adhesive may be mixed with the solvent in a ratio of about 0.1 parts epoxy adhesive to 99.9 parts solvent, or about 1 parts epoxy adhesive to about 99 parts solvent, or between about 10 parts epoxy adhesive to 90 parts solvent.

Subsequently, the dilute epoxy adhesive was draw bar coated to form a thin uniform film of dilute epoxy adhesive on a polyimide surface. The surface material will depend on the application, and may include metals such as stainless steel or aluminum, or polymers other than polyimide. Draw bar coating formed a dilute epoxy adhesive on the polyimide surface having a thickness of between about 0.1 micrometer (μm) and about 100 μm, or between about 1.0 μm and about 50 μm, or between about 3.0 μm and about 10 μm. The thickness of the dilute epoxy adhesive thickness may be controlled by the mixing ratio of the epoxy adhesive and the solvent. Prior to applying the dilute epoxy adhesive, the polyimide surface was treated by exposing the polyimide surface to an oxygen plasma. Without being bound to any specific theory, it is believed that the oxygen plasma treatment prepared the polyimide surface by creating chemically active functional groups, such as carbonyl, hydroxyl, and carboxyl groups to improve interfacial adhesion. Oxygen plasma treatment may also be performed on a metal surface to improve the bondability with the dilute epoxy adhesive.

After application of the dilute epoxy adhesive onto the polyimide surface, the solvent was evaporated from the dilute epoxy adhesive by air drying to form a B-staged thin film epoxy adhesive. The B-staged thin film epoxy adhesive may have a thickness of between about 0.1 μm and about 100 μm, or between about 1.0 μm and about 50 μm, or between about 3 μm and about 10 μm. B-staging the epoxy adhesive allows handling of the coated polyimide without compromising the B-staged thin film epoxy adhesive.

After forming the B-staged thin film epoxy adhesive on a first side of the polyimide surface, the process described above may be repeated on a second side of the polyimide surface that is opposite to the first side to prepare a double-sided polyimide film (i.e., a polyimide film with a coating of the B-staged thin film epoxy adhesive on two different sides).

After forming the coated polyimide, the material may be cut into a desired shape and/or size using, for example, a laser cutting process. In an embodiment, the coated polyimide is laser cut into printhead interstitial features.

Subsequently, a second substrate may be bonded to the polyimide film first substrate using the B-staged thin film epoxy adhesive. In an embodiment, the second substrate may be a metal layer or a polymer layer, for example a stainless steel layer, an aluminum layer, or a polyimide film. In an embodiment, the second substrate is placed in physical contact with the B-staged thin film epoxy adhesive on the first substrate to form a printhead subassembly, wherein the B-staged thin film epoxy adhesive is interposed between the first substrate and the second substrate. The B-staged thin film epoxy adhesive is then cured to form a fully cured epoxy adhesive that bonds the first substrate to the second substrate.

In an embodiment, full curing of the B-staged thin film epoxy adhesive can be performed by placing the printhead subassembly into a jet stack press as part of a jet stack assembly process. The use of a jet stack press during printhead assembly is well known in the art. With this particular process, the printhead subassembly may be subjected to a press pressure of between about 1.0 psi and about 1000 psi, or between about 10 psi and about 500 psi, or between about 50 psi and about 200 psi. During the application of pressure, the printhead subassembly may be subjected to a temperature sufficient to fully cure the B-staged thin film epoxy adhesive to form a fully cured adhesive, for example a temperature of between about 100° C. and about 300° C., or between about 150° C. and about 200° C., or between about 180° C. and about 190° C. The pressure and temperature may be applied to the printhead subassembly for a duration of between about 20 minutes and about 200 minutes, or between about 60 minutes and about 100 minutes.

During testing, it was found that a shear strength of the adhesive after bonding is inversely proportional to the thickness of the adhesive, down to an epoxy adhesive thickness of about 3.0 μm. Testing was not performed at adhesive thicknesses of less than about 3.0 μm.

In an embodiment, the epoxy adhesive may be used, referring to FIG. 1, as the external manifold adhesive 18, the diverter attach adhesive 22, the aperture plate adhesive 48, the boss plate adhesive 70, the diaphragm adhesive 72, or generally any printhead adhesive. The epoxy adhesive may be used to physically attach any combination of one or more metals (e.g., stainless steel, aluminum, copper, metal alloy, etc.), one or more semiconductors (e.g., silicon, gallium arsenide, etc.), and/or one or more organic or inorganic polymers (e.g., polyimide, nylon, silicone, etc.).

During testing, it was found that a cured epoxy adhesive prepared according one or more of the process embodiments described above demonstrated characteristics and properties well suited for printhead applications. In one test, the cured epoxy adhesive was used to attach a piezoelectric element to a diaphragm, and the cured epoxy adhesive demonstrated good thermal oxidative stability (i.e., the material showed little or no oxidation). After aging in 170° C. hot air, no jet stack opens occurred due to aging after 85 days of continuous testing. In contrast, some conventional adhesives became stiffer when aged in 170° C. hot air, and bonding failures occurred in 35 days of continuous testing.

Additionally, weight gain (i.e., mass uptake) of an adhesive during exposure to harsh inks results in swelling, which can cause leakage or bursting of the printhead during high-temperature, high-pressure use. In an embodiment of the present teachings, when exposed to gel UV ink, the cured epoxy adhesive resisted weight gain and swelling (i.e., less than 2% weight gain) and is thus compatible with harsh inks. In contrast, some conventional inks used in printhead fabrication show marked weight change when exposed to harsh inks, in some cases a percent change in weight of as much as 160% after less than 1000 hours of testing. During UV ink soak testing, a polyamide-imide adhesive had a weight gain of 28% after 14 weeks, an epoxy-acrylic based adhesive had a weight gain of 68% after 1 week, a modified acrylic adhesive had a weight gain of 68% after 2 weeks, and a nitrile phenolic-based adhesive dissolved in the UV ink.

The cured epoxy adhesive prepared and formed using an embodiment of the process as described above (i.e., the “subject material”) demonstrated several characteristics desirable with printhead fabrication, as described below.

It is well known that piezoelectric material used in piezoelectric elements are subject to de-poling when exposed to high temperatures. While some epoxy adhesives require a high-temperature cure, the subject material is fully cured when exposed to a temperature of 200° C. or less for a duration of between about 60 minutes and about 70 minutes.

While some epoxy adhesives are cured using high pressures, for example pressures greater than 200 psi, the subject material may be cured at pressures of 200 psi or less, for example 100 psi or less, for example about 30 psi. Extreme pressures are avoided where possible during printhead manufacture, as various printhead structures such as piezoelectric elements and electrical circuits may be damaged during high pressure assembly processes. Still, high pressures are used in conventional processes with some conventional adhesives to improve adhesive bonding and printhead reliability.

Wicking or squeeze out of adhesive occurs when the cured adhesive has a change in dimension of 5% or greater, which can lead to leakage of ink or bursting of the printhead during high-pressure printing. For example, pressures within a solid ink jet printhead can reach up to 10 psi. The subject material demonstrated a squeeze out of less than 5%.

Some adhesives have a high surface roughness, for example greater than 0.5 μm peak-to-peak. Surface roughness may result in trapped air bubbles within the adhesive which expand and contract during a change in temperature and may fatigue the adhesive and result in ink leakage or bursting of the printhead during high-pressure printing. The subject material demonstrated a surface flatness (both sides) of less than 0.5 μm peak-to-peak.

To provide sufficient bonding of metal to metal, metal to polyimide, or polyimide to polyimide, an adhesive must provide a lap shear strength, regardless of the material, of greater than about 200 psi. Some adhesives minimally meet this tolerance, do not meet this tolerance, or meet the tolerance only at room temperatures. The subject material demonstrated a lap bonding strength at a thickness of about 5.0 μm of about 1000 psi both at room temperature (20° C.) and at 115° C. For this test, the epoxy adhesive was cured at a temperature of 190° C. for 70 minutes at 200 psi.

As discussed above, an adhesive should be chemically stable when exposed to organic inks such as UV gel inks and pigmented inks. Some inks may swell or oxidize when exposed to inks. In contrast, the subject material demonstrated little or no weight gain (less than 2%) when exposed continuously to a pigmented ink and a UV gel ink for 30 weeks. Additionally, the subject material resisted oxidation, in that no jetstack openings were observed when exposing the subject material to hot air at 170° C. for over 80 days from a PZT aging study.

Because an adhesive may be used to physically couple two conductive surfaces, an adhesive should be non-conductive (i.e., an insulator). While some adhesives are conductive or semiconductive, a volume resistivity of the subject material may be about 10E12 ohm-cm.

To reduce ink leakage between adjacent layers, a particle size of a filler material within an adhesive should be as small as possible. Fillers within the subject material have a maximum particle size of less than 1.0 μm in diameter.

To minimize costs, an adhesive should have a long shelf life. The subject material has a shelf life of greater than one month at 20° C., and at least one year at 0° C.

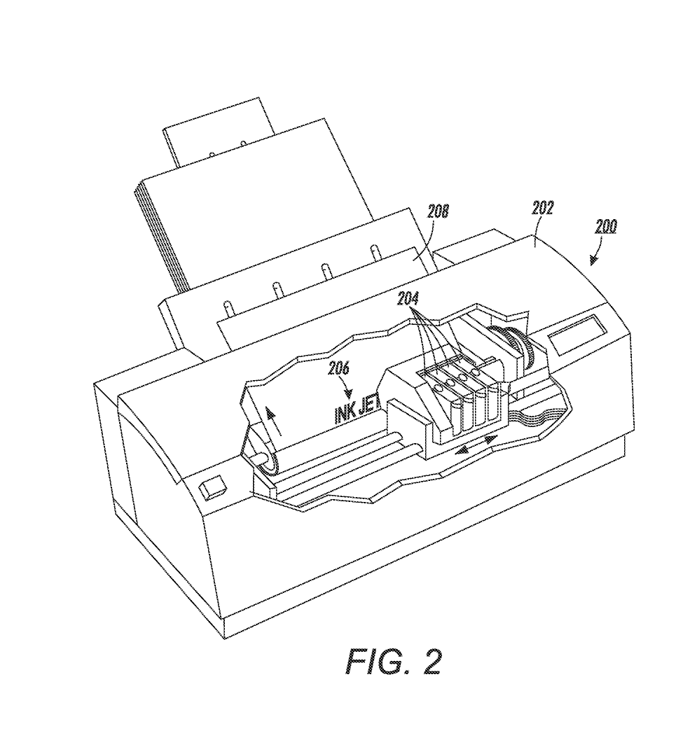

After forming a laminated printhead structure, the printhead is filled with an ink 206 (FIG. 2), for example a UV ink or a pigmented ink. These inks are particularly chemically reactive with conventional epoxy adhesives applied using conventional techniques, which are exposed to the ink within the printhead. In an embodiment, the subject materials resists chemical reaction with the ink, for example weight gain, swelling, and oxidation.

FIG. 2 depicts a printer 200 including a printer housing 202 into which at least one printhead 204 including an embodiment of the present teachings has been installed and that encases the printhead 204. During operation, ink 206 is ejected from one or more printheads 204. The printhead 204 is operated in accordance with digital instructions to create a desired image on a print medium 208 such as a paper sheet, plastic, etc. The printhead 204 may move back and forth relative to the print medium 208 in a scanning motion to generate the printed image swath by swath. Alternately, the printhead 204 may be held fixed and the print medium 208 moved relative to it, creating an image as wide as the printhead 204 in a single pass. The printhead 204 can be narrower than, or as wide as, the print medium 208. In another embodiment, the printhead 204 can print to an intermediate surface such as a rotating drum or belt (not depicted for simplicity) for subsequent transfer to a print medium.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the workpiece, regardless of the orientation of the workpiece.

1. A method for forming an ink jet printhead, comprising:
mixing a cresol novolac resin with a dicydiandiamide curing agent to result in an epoxy adhesive;
dissolving the epoxy adhesive in a solvent to form a dilute epoxy adhesive in a coatable form;
coating a first substrate comprising at least one of a metal and a polymer with the dilute epoxy adhesive;
B-staging the epoxy adhesive by evaporating the solvent from the dilute epoxy adhesive after coating the first substrate with the dilute epoxy adhesive to form a B-staged thin film epoxy adhesive;
contacting the B-staged thin film epoxy adhesive with a second substrate comprising at least one of a metal and a polymer to form a printhead subassembly, wherein the B-staged thin film epoxy adhesive is interposed between the first substrate and the second substrate; and
fully curing the B-staged thin film epoxy adhesive to form a fully cured epoxy adhesive and to bond the first printhead substrate to the second printhead substrate using the fully cured epoxy adhesive.

2. The method of claim 1, further comprising fully curing the B-staged thin film epoxy adhesive using a method comprising:
placing the printhead subassembly into a jet stack press;
subjecting the printhead subassembly to a pressure of between about 50 psi and about 200 psi within the jet stack press; and
subjecting the printhead subassembly to a temperature of between about 150° C. and about 200° C. within the jet stack press.

3. The method of claim 2, wherein the first substrate is a polyimide first substrate and the method further comprises exposing the polyimide first substrate to an oxygen plasma prior to coating the polyimide first substrate with the dilute epoxy adhesive.

4. The method of claim 2, wherein the first substrate is a polyimide first substrate and the second substrate is a metal second substrate and the method further comprises exposing the polyimide first substrate to an oxygen plasma prior to coating the polyimide first substrate with the dilute epoxy adhesive.

5. The method of claim 2, wherein the first substrate is a metal first substrate and the second substrate is a polyimide second substrate and the method further comprises exposing the metal first substrate to an oxygen plasma prior to coating the metal first substrate with the dilute epoxy adhesive.

6. The method of claim 1, further comprising providing the cresol novolac resin, wherein the cresol novolac resin is a phenolic aromatic organic compound of methylphenol.

7. The method of claim 1, further comprising providing the cresol novolac resin, wherein a chemical structure of the cresol novolac resin comprises:

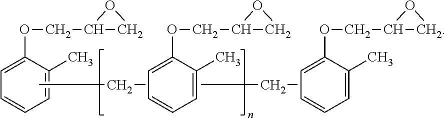

8. The method of claim 7, further comprising providing the dicydiandiamide curing agent, wherein a chemical structure of the dicydiandiamide curing agent comprises:

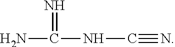

9. The method of claim 8, further comprising:
filling the ink jet printhead with an ink, wherein the ink comprises at least one of an ultraviolet (UV) gel ink and a pigmented ink; and
exposing the fully cured epoxy adhesive to the ink.

10. The method of claim 1, further comprising providing the cresol novolac resin, wherein a chemical structure of the cresol novolac resin comprises:

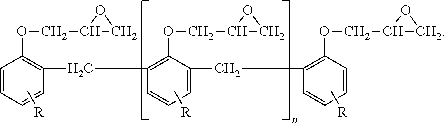

11. The method of claim 10, further comprising providing the dicydiandiamide curing agent, wherein a chemical structure of the dicydiandiamide curing agent comprises:

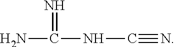

12. The method of claim 11, further comprising:
filling the ink jet printhead with an ink, wherein the ink comprises at least one of an ultraviolet (UV) gel ink and a pigmented ink; and
exposing the fully cured epoxy adhesive to the ink.

13. The method of claim 1, further comprising dissolving the epoxy adhesive in a solvent selected from the group consisting of methylene chloride, acetone, methyl ethyl ketone, toluene, 1,2, dimethoxyethane, ethanol, methanol, and mixtures thereof.

14. The method of claim 13, further comprising dissolving the epoxy adhesive in the solvent in a ratio of about 10 parts epoxy adhesive to about 90 parts solvent to form the dilute epoxy adhesive.

15. The method of claim 1, further comprising draw bar coating the dilute epoxy adhesive onto the first substrate to a thickness of between about 3.0 μm and about 10 μm.

16. An ink jet printhead, comprising:
a first substrate;
a second substrate;
an epoxy adhesive interposed between the first substrate and the second substrate that physically connects the first substrate to the second substrate, wherein the epoxy adhesive:
comprises a cresol novolac resin and a dicydiandiamide curing agent;
has a material surface flatness of less than or equal to 0.5. microns peak-to-peak;
has a lap shear strength greater than 200 psi bonding the first substrate to the second substrate; and
is an electrical insulator; and
an ink within the ink jet printhead that physically contacts the epoxy adhesive, wherein the ink is an ultraviolet gel ink or a pigmented ink, and the epoxy adhesive has a mass uptake of less than 2% when exposed continuously to the ink for 30 weeks.

17. The ink jet printhead of claim 16, wherein a storage modulus of the epoxy adhesive is between about 100 megapascals (MPa) and about 1500 MPa at a temperature of 20° C. and between about 3 MPa and about 700 MPa at a temperature of 120° C.

18. The ink jet printhead of claim 16, wherein the epoxy adhesive further comprises a filler material comprising a plurality of particulates, wherein each of the plurality of particles has a maximum diameter of 1 μm.

19. The ink jet printhead of claim 16, wherein the epoxy adhesive has a shelf life of greater than one month at 20° C. and greater than one year at 0° C.
